(19) United States
(12) Patent Application Publication
(10) Pub. No.: US 2026/0081143 A1
(43) Pub. Date: Mar. 19, 2026

(54) ACTIVE MATERIAL METALIZED SEPERATOR AND ANODE ASSEMBLY FOR ENERGY STORAGE

(71) Applicant: Li-Metal Corp., Markham (CA)

(72) Inventors: Maciej JASTRZEBSKI, Toronto (CA); Kristyn M. ZOSCHKE, Markham (CA)

(21) Appl. No.: 19/332,684

(22) Filed: Sep. 18, 2025

Related U.S. Application Data
(60) Provisional application No. 63/695,935, filed on Sep. 18, 2024.

(51) Int. Cl. H01M 4/38; H01M 4/02; H01M 4/04; H01M 50/414

(52) U.S. Cl. CPC H01M 4/382; H01M 4/0423; H01M 50/414; H01M 2004/027

(57) ABSTRACT

A metalized separator includes: a separator substrate having a first surface; and a layer of metallic active anode material deposited on the first surface. The layer of metallic active anode material may be deposited by physical vapour deposition (PVD). A separator assembly including the metalized separator, a battery cell containing one or more of the metalized separators, and a process of producing the metalized separator, are also disclosed.

### CROSS-REFERENCE TO RELATED APPLICATIONS

This application claims the benefit of U.S. Provisional Application No. 63/695,935 filed Sep. 18, 2024, the content of which is incorporated herein by reference in its entirety.

### FIELD OF THE INVENTION

The present invention relates generally to battery cells and in particular, to a metalized separator for a battery cell a battery cell containing the same.

### BACKGROUND

High-energy density storage batteries use high energy anode active materials such as lithium, sodium, or other alkali metals or alkaline earth metals. These are incorporated in layered structures, comprising repeating, mirrored basic units comprising a current collector, anode active material, separator, cathode active material, and current collector. The entire assembly is typically soaked with a liquid electrolyte or, in the case of solid-state batteries, the electrolyte is incorporated into the separator and cathode active material, to form an energy storage cell.

A method for production of such anode materials containing alkali or alkaline metal materials is physical vapour deposition. In this method, anode components are typically made by evaporating the active anode material onto both sides of a substrate, typically copper, which serves the function of current collector.

One drawback to the prior art, is that in order to maintain shelf-life, the surface of the anode active material must be passivated to avoid reactions with ambient oxygen, nitrogen, carbon dioxide and moisture, which negatively affect the performance of the cell. While this passivation is able to slow the degradation of the surface, it introduces materials to the interface of the active material which themselves limit maximum performance of the cell.

A second drawback is that double-sided coating of the substrate inevitably results in the active material on one side of the substrate is exposed to web-handling equipment and the thermal effects associated with the coating process which coats the active material on the complimentary side. This can lead to defects or non-uniform properties between the two sides of active material.

A third drawback is that the top surface, which becomes the interfacing surface in the cell, typically has a significant, systematic curvature and texture that can have a negative impact on stripping and plating uniformity. This drawback can also apply more generally to interfacial contact of lithium with a solid state electrolyte in a variety of different lithium metal-SSE systems. Even with improved surface flatness, microscopic surface roughness of both materials creates resistance at the interface which is one of the most significant technical challenges with SSB. See proposed 5th drawback added.

A fourth drawback is that the substrate material, typically copper, adds weight and volume to the cell, reducing its specific energy and energy density, and increases the final cost of the cell.

A fifth drawback is that the interfacial resistance between a typical lithium metal anode and solid electrolyte system is influenced by mismatched surface morphologies of the two materials, leading to poor contact pre-cycling. Interfacial resistance is a key technical challenge limiting charge/discharge rates and dendrite formation in all SSB systems.

### SUMMARY

In one aspect, there is provided a metalized separator comprising: a) a separator substrate having a first surface; and b) a layer of metallic active anode material deposited on the first surface, such as by physical vapour deposition (PVD).

The separator substrate may comprise a polymer.

The separator substrate may comprise a solid-state separator.

The layer of metallic active anode material may comprise at least one of Li, Na, K, Mg, Ca, Al or alloys thereof.

The layer of metallic active anode material may comprise lithium.

The layer of metallic active anode material may have a thickness measured in a direction away from the first surface, and optionally the thickness may not be uniform throughout the layer of metallic active anode material.

The layer of metallic active anode material may have an ear of reduced thickness forming a recess that is sized and shaped to receive a metallic tab.

The metalized separator may further comprise at least one of a conductive layer and a performance-enhancing layer covering at least a portion of the layer of metallic active anode material, and comprising at least one tin (Sn), zinc (Zn), magnesium (Mg), carbon (C), indium (In), silver (Ag), bismuth (Bi), lead (Pb), selenium (Se), copper (Cu), nickel (Ni), stainless steel and steel, titanium (Ti), zirconium (Zr), molybdenum (Mo), nitrides (such as lithium nitride), hydrides (such as lithium hydride), carbonates (such as lithium carbonate), oxides (such as lithium oxide), sulphides (such as lithium sulphide), lithium-ion conducting polymers (such as PEO and lithium catechol), gold (Au), platinum (Pt), other materials described herein or alloys thereof.

In one embodiment, there is provided a separator assembly comprising the metalized separator bonded to a current collector.

In another embodiment, there is provided a battery cell containing one or more of the metalized separators.

In still another embodiment, there is provided a process of producing the metalized separator, the process comprising: depositing a layer of metallic active anode material deposited on a first surface or a separator substrate, such as by physical vapour deposition (PVD).

### BRIEF DESCRIPTION OF THE DRAWINGS

FIG. 1 is a schematic representation of one example of a battery cell stack;

FIG. 2 is a schematic representation of a PVD anode in accordance with one know prior art arrangement;

FIG. 3 is a schematic representation of or example of a lithiated separator;

FIG. 4 is a schematic representation of one example of a lithiated anode/separator assembly including a metallic tab;

FIG. 5 is a schematic representation of another example of a lithiated anode/separator assembly including a current collector;

FIG. 6 is a schematic representation of another example of a lithiated separator assembly including a conductive; and

FIG. 7 is a schematic representation of another example of a lithiated separator assembly including a performance enhancing layer and a conductive layer.

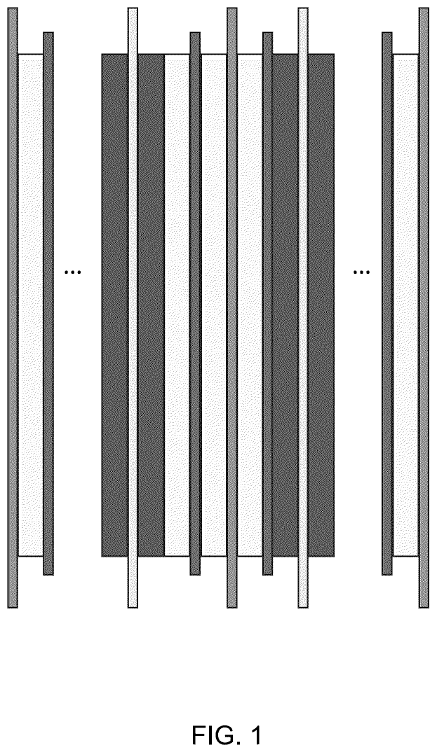

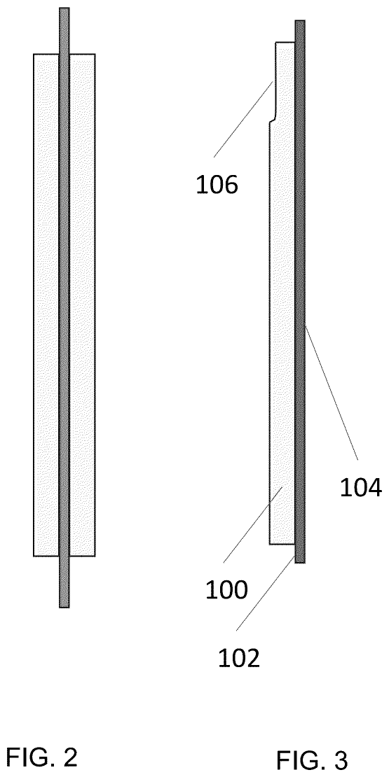

### DESCRIPTION OF EMBODIMENTS

The teachings described herein are, at least in part, aimed at overcoming and/or mitigating at least some of the drawbacks of the prior art described herein by providing an improved method of incorporating active anode material, an anode assembly and method for producing the same, but any given embodiment need not overcome all, or any of the particular drawbacks described herein.

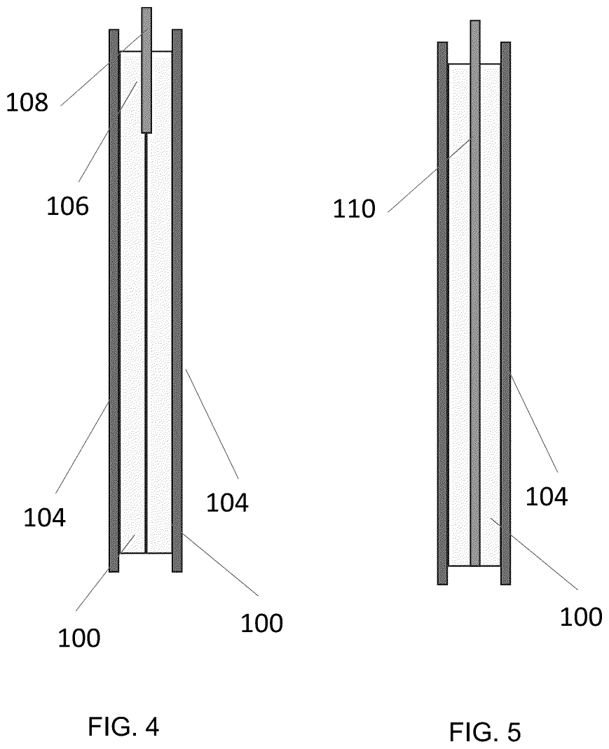

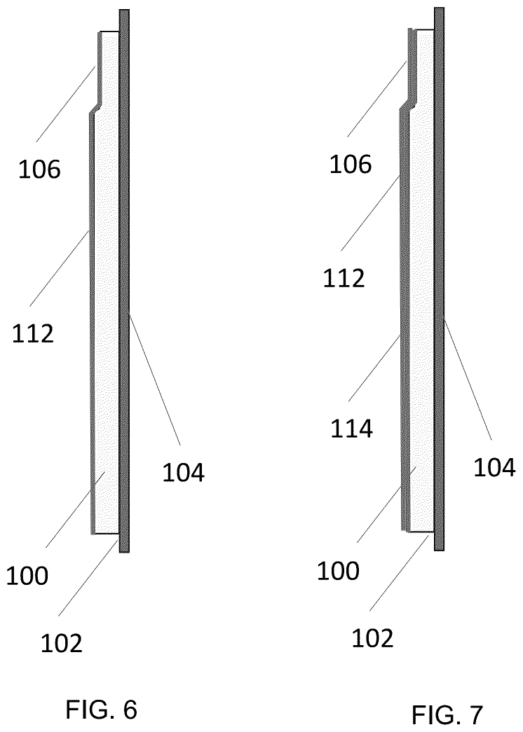

One of the examples described herein can include lithium, or another metallic active anode material 100 that is deposited onto a single surface 102 of a polymeric or solid-state separator 104, such as via physical vapor deposition. Pairs of such lithiated or active material metallized separators can be assembled by lamination, calendaring or other process such that the two metallized surfaces are bonded together (this may occur spontaneously under roll pressure), such as is shown in FIG. 4.

The PVD source can be modulated, using baffles, masks, zone heating or multiple sources to produce an area of reduced thickness 106 within the deposited active anode material 100, thereby forming a recess or similar formation that can allow a copper or other metallic tab 108 to be inserted for facilitating an electrical connection terminal.

Alternatively, the two lithiated or active material metallized separators can be laminated directly onto a foil current collector 110 (see FIG. 5) to create a more robust conduction path as needed in, for example, high power battery cells.

One advantage of this arrangement may be that, unlike the prior art, the substrate/separator protects the front, and therefore more critical, surface of the anode active material from reactions with atmospheric air, thereby reducing and/or obviating the need for passivation, such as via a separate passivation layer or coating. The atmosphere-affected surface is relegated to the rear side of the active material where its surface characteristics are much less relevant to its performance within a cell.

Another advantage of this arrangement may be that the front surface morphology (roughness, uniformity) is shaped by the surface of the separator, which is generally a smooth polymeric sheet. This leads to more favorable morphology that improves stripping and plating performance. Lamination or calendaring of the two sides reduces the systematic curvature normally present in PVD coated anode materials.

Another advantage of this arrangement may be that by only requiring coating on one side of the substrate, it is possible to complete the coating operation in a “contact free” mode, where the active material does not contact the web-handling equipment in the PVD machine, which reduces the likelihood of defects. By only coating one side, the thermal alteration present in the prior art from coating on the obverse side is eliminated, and the coating equipment greatly simplified.

Another advantage of this arrangement may be that the amount of current collector material can be minimized to only that which is required to support the flow of current, allow the use of lightweighted mesh current collectors, or current collector-less (tab only) designs.

Optionally, in some other examples the assembly may include a lithium, or another metallic active anode material 100 that is deposited onto a single surface 102 of a polymeric or solid-state separator 104 and then can include one or more additional, performance-enhancing/modifying layers between the active material and conductive material (such as the tab 108 or current collector 110). For example, referring to FIGS. 7 and 8, some examples can include a conductive layer 112 applied to or deposited on the active material 100, and/or an alternative performance enhancing layer 114.

As used herein, the term film or layer describes the amount of a given material, such as the protective material, a gas protection layer material, a conductivity film material, a performance enhancing film material, and the like, that is generally continuous and is not interrupted by intervening materials or structures. Any given film or layer may be formed by a single application of the or the material (e.g. a single pass of a physical vapour deposition process as described herein) that applies all of the material for a film of a given thickness in a single step or process. Alternatively, a single film as described herein may also be formed as the result/combination of two or more applications of the film material (e.g. via multiple passes of a physical vapour deposition process as described herein) that each apply a portion of the film material and the total film thickness is measured on the film formed by accumulating the material from the two or more applications

### Variations:

Active Anode Materials—Li, Na, K, Mg, Ca, Al

Current Collector: Cu foil, metallized polymer with Cu or other conductive metal coating, Cu foil with another performance-enhancing or bonding layer (Zn, Mg, Ag or any of the other layers as described herein). That is, the conductive layer 112 and performance enhancing layer 114 can include suitable types of conductive layers, interface layers, including the examples of layers described below.

The layers may, for example function as an interface material that can provide a variety of functions within the anode assembly. For example, the interface films/layers can have performance enhancing characteristics, they may be lithium ion blocking and electronically conductive (e.g. to allow an electron flux through the interface film and interface region), they may be electronically conductive but not lithium ion blocking, they may be lithiophilic or plating enhancing, and may help facilitate bonding or other property-matching between adjacent layers, films or regions such as thermal expansion matching, improving bonding between layer, etc. Examples of materials that can be suitable for use as an interface material and can have deposition-enhancing and lithiophilic properties (and for forming films within the interface region) can include, for example, tin (Sn), zinc (Zn), magnesium (Mg), carbon (C), indium (In), silver (Ag), bismuth (Bi), lead (Pb) and selenium (Se). Examples of materials that can be suitable for use as a lithium ion flux-inhibiting interface material that are electronically conductive (to facilities electron transfer) and can help block lithium ion flux (and for forming a flux-inhibiting or protective film within the interface region or optionally within the substrate region) can include, for example, copper (Cu), nickel (Ni), chromium (Cr), tungsten (W), tantalum (Ta), iron (Fe), titanium (Ti), zirconium (Zr), molybdenum (Mo) and alloys thereof. Examples of materials that can be suitable for use as an interface material and can help provide property-matching and/or improved material bonding properties (and for forming a layer within the interface region) can include, for example, zinc (Zn), cadmium (Cd), copper (Cu), magnesium (Mg), antimony (Sb), indium (In), bismuth (Bi), nickel (Ni), lead (Pb) and selenium (Se).

These layers can also optionally include films, for example, passivation films (configured to inhibit irreversible reactions between the lithium hosting region and the electrolyte or surrounding environment, such as by inhibiting gas diffusion and allowing lithium ion flux through the first passivation film), deposition-enhancing films (configured to improve lithium ion flux or ion distribution between the lithium hosting region and the electrolyte when in use), lithiophilic cover films (configured to help enhance transfer of lithium ions so that dendrite formation is inhibited when lithium is deposited in the lithium hosting region when the anode assembly is in use). Some examples of materials that can be used to form deposition-enhancing and/or lithiophilic films in the cover region can include, for example, tin (Sn), zinc (Zn), magnesium (Mg), carbon (C), indium (In), silver (Ag), bismuth (Bi) and lead (Pb). Some examples materials that can be used to form passivation films in the cover region can include, nitrides (such as lithium nitride), hydrides (such as lithium hydride), carbonates (such as lithium carbonate), oxides (such as lithium oxide), sulphides (such as lithium sulphide), lithium-ion conducting polymers (such as PEO and lithium catehcols), gold (Au), platinum (Pt) and the like.

These layers can also optionally include could include a protective layer, such as from a protective metal that is electronically conductive and resistive to lithium ion flux whereby electrons can travel through the first protective film from the lithium hosting region to the current collector and the lithium hosting region is spaced from and at least substantially ionically isolated from the current collector such that and diffusion of lithium ions from the lithium hosting region to the current collector through the first protective film is substantially prevented. The protective metal may include at least one of copper (Cu), nickel (Ni), silver (Ag), stainless steel and steel, titanium (Ti), zirconium (Zr), molybdenum (Mo), or alloys thereof.
Production Process/Structure—Separator, active material deposited by PVD, current collector conductive material deposited by PVD, and forming the final assembly by laminating the two separator assemblies together with a tab, rather than on current collector foil to achieve the high-power battery cell.

While any suitable type of physical deposition apparatus can be used, the inventors have determined generally that lithium material can be applied using a thermal evaporation source, polymers can be applied using a thermal evaporation source, chromium (Cr), tungsten (W), titanium (Ti), zirconium (Zr), molybdenum (Mo) and the like may be applied via a magnetron or electron beam applicator (preferably a magnetron), other metals described herein can be applied by via thermal evaporation, a magnetron, or an electron beam applicator (but preferably are applied using a magnetron) and the oxides, hydrides and carbonates and other such materials can be created using a suitable gas source to create an in situ reaction on the surface of the assembly or via a magnetron.

What is claimed is:

1. A metalized separator comprising:
a) a separator substrate having a first surface; and
b) a layer of metallic active anode material deposited on the first surface.

2. The metalized separator of claim 1, wherein the layer of metallic active anode material is deposited by physical vapour deposition (PVD).

3. The metalized separator of claim 1, wherein the separator substrate comprises a polymer.

4. The metalized separator of claim 1, wherein the separator substrate comprises a solid-state separator.

5. The metalized separator of claim 1, wherein the layer of metallic active anode material comprises at least one of Li, Na, K, Mg, Ca, Al, or an alloy thereof.

6. The metalized separator of claim 1, wherein the layer of metallic active anode material comprises lithium.

7. The metalized separator of claim 1, wherein the layer of metallic active anode material has a thickness measured in a direction away from the first surface.

8. The metalized separator of claim 7, wherein the thickness is not uniform throughout the layer of metallic active anode material.

9. The metalized separator of claim 1, wherein the layer of metallic active anode material has an ear of reduced thickness forming a recess that is sized and shaped to receive a metallic tab.

11. The metalized separator of claim 1, further comprising at least one of a conductive layer and a performance-enhancing layer covering at least a portion of the layer of metallic active anode material, and comprising at least one of tin (Sn), zinc (Zn), magnesium (Mg), carbon (C), indium (In), silver (Ag), bismuth (Bi), lead (Pb), selenium (Se), copper (Cu), nickel (Ni), steel, stainless steel, titanium (Ti), zirconium (Zr), molybdenum (Mo), nitrides (such as lithium nitride), hydrides (such as lithium hydride), carbonates (such as lithium carbonate), oxides (such as lithium oxide), sulphides (such as lithium sulphide), lithium-ion conducting polymers (such as PEO and lithium catechol), gold (Au), platinum (Pt), and alloys thereof.

12. A separator assembly comprising the metalized separator of claim 1 bonded to a current collector.

13. A battery cell containing one or more of the metalized separators of claim 1.

14. A process of producing the metalized separator of claim 1, the process comprising:
depositing a layer of metallic active anode material deposited on a first surface or a separator substrate.

15. The process of claim 14, wherein the deposited is carried out by physical vapour deposition (PVD).
